(19) United States
(12) Patent Application Publication
(10) Pub. No.: US 2025/0154308 A1
(43) Pub. Date: May 15, 2025

(54) ELECTRODE SLURRY ADDITIVE AND SOLID-STATE BATTERY

(71) Applicants: Ryosuke Furuya, Gotemba-shi (JP); Yukari Ishimoto, Hiratsuka-shi (JP); Atsushi Tsukamoto, Yokohama-shi (JP); Yoshiyuki Yukawa, Nagoya-shi (JP)

(72) Inventors: Ryosuke Furuya, Gotemba-shi (JP); Yukari Ishimoto, Hiratsuka-shi (JP); Atsushi Tsukamoto, Yokohama-shi (JP); Yoshiyuki Yukawa, Nagoya-shi (JP)

(73) Assignees: TOYOTA JIDOSHA KABUSHIKI KAISHA, Toyota-shi (JP); KANSAI PAINT CO., LTD., Amagasaki-shi (JP)

(21) Appl. No.: 18/940,181

(22) Filed: Nov. 7, 2024

(30) Foreign Application Priority Data
Nov. 10, 2023 (JP) 2023-192554

(51) Int. Cl. C08F 265/06; H01M 4/62

(52) U.S. Cl. CPC C08F 265/06; H01M 4/62

(57) ABSTRACT

An electrode slurry additive is an acrylic resin including a structural unit having a linear alkyl group with 14 or more carbon atoms and a structural unit having a basic functional group, has a weight average molecular weight that is greater than 50,000 and less than 200,000, and has an amine value of from 5 mg KOH/g to 33 mg KOH/g. A solid-state battery includes the electrode slurry additive.

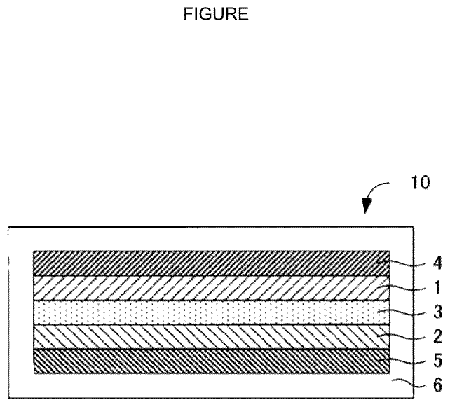

### CROSS-REFERENCE TO RELATED APPLICATION

This application is based on and claims priority under 35 USC 119 from Japanese Patent Application No. 2023-192554, filed on Nov. 10, 2023, the disclosure of which is incorporated by reference herein.

### BACKGROUND

### Technical Field

The present disclosure relates to an electrode slurry additive and a solid-state battery.

### Related Art

When making an electrode having an electrode layer including an active material, there are cases where the electrode having the electrode layer is prepared by applying and drying a slurry including the active material (hereinafter also called “the electrode slurry”). In some cases, additives (electrode slurry additives) are also used in the electrode slurry to improve the dispersion stability of components in the slurry such as the active material.

Japanese Patent Application Laid-open (JP-A) No. 2011-014387 proposes an all-solid-state secondary battery having a positive electrode, a solid electrolyte layer, and a negative electrode, characterized in that at least one of the positive electrode, the solid electrolyte layer, and the negative electrode includes a graft polymer.

International Publication No. 2022-085637 proposes an inorganic solid-state electrolyte-containing composition comprising: an inorganic solid-state electrolyte having conductivity for an ion of a metal belonging to Group 1 or Group 2 in the periodic table; a polymer binder; and a dispersion medium, wherein the polymer binder includes a polymer that contains a constitutional component (X) having a polymerization chain and a constitutional component (A) having at least one functional group from the group (a) of functional groups, and contains a constitutional component (N) containing a nitrogen atom at a content of less than 10% by mole with respect to all constitutional components, and the polymer binder dissolves in the dispersion medium.

### SUMMARY

The graft polymer which is an electrode slurry additive described in JP-A No. 2011-014387 does not have an adsorption group (e.g., a basic functional group) for the active material and the like, so the graft polymer tends to have poor active material dispersibility. Furthermore, the polymer binder which is an electrode slurry additive described in International Publication No. 2022/085637 has an acidic functional group, so in a case where the electrode slurry contains a solid-state electrolyte, the polymer binder tends to easily cause deterioration of the solid-state electrolyte and may lack versatility.

In the present disclosure, an additive added to an electrode slurry to improve the dispersion stability of components (the active material and the like) used in the preparation of the electrode slurry is also called an “electrode slurry additive.”

An embodiment of the present disclosure addresses provision of an electrode slurry additive that improves the dispersion stability of components in a slurry.

Another embodiment of the present disclosure addresses provision of a solid-state battery including an electrode slurry additive that improves the dispersion stability of components in a slurry.

Aspects according to the present disclosure include the following aspects.

A first aspect of the present disclosure provides an electrode slurry additive, which:
is an acrylic resin including a structural unit having a linear alkyl group with 14 or more carbon atoms and a structural unit having a basic functional group,
has a weight average molecular weight that is greater than 50,000 and less than 200,000, and
has an amine value of from 5 mg KOH/g to 33 mg KOH/g.

A second aspect of the present disclosure provides an electrode slurry additive of the first aspect, wherein the content ratio of the structural unit having a linear alkyl group with 14 or more carbon atoms is from 30% by mass to 65% by mass relative to all structural units included in the acrylic resin.

A third aspect of the present disclosure provides an electrode slurry additive of the first or second aspect, wherein the content ratio of the structural unit having a basic functional group is from 0.5% by mass to 10% by mass relative to all structural units included in the acrylic resin.

A fourth aspect of the present disclosure provides an electrode slurry additive of any one of the first to third aspects, wherein the electrode slurry additive is a random polymer.

A fifth aspect of the present disclosure provides an electrode slurry including the electrode slurry additive of any one of the first to fourth aspects, an active material, a conductive aid, a solid-state electrolyte, and a solvent.

A sixth aspect of the present disclosure provides an electrode slurry of the fifth aspect, wherein the solvent is selected from the group consisting of butyl butyrate, dibutyl ether, anisole, mesitylene, diisobutyl ketone, methyl isobutyl ketone, cyclopentyl methyl ether, toluene, and heptane.

A seventh aspect of the present disclosure provides an electrode including the electrode slurry additive of any one of the first to fourth aspects.

An eighth aspect of the present disclosure provides a solid-state battery, including the electrode slurry additive of any one of the first to fourth aspects.

According to an embodiment of the present disclosure, there is provided an electrode slurry additive that improves the dispersion stability of components in a slurry.

According to another embodiment of the present disclosure, there is provided a solid-state battery including an electrode slurry additive that improves the dispersion stability of components in a slurry.

### BRIEF DESCRIPTION OF THE DRAWINGS

The FIGURE is a schematic cross-sectional view illustrating one embodiment of a battery of the present disclosure.

### DETAILED DESCRIPTION

An embodiment which is an example of the present disclosure will be described below. These descriptions and Examples are illustrative of the embodiment and are not intended to limit the scope of the invention.

The term “step” includes not only an independent step but also a step that cannot be clearly distinguished from another step as long as the desired action of the step is achieved.

“Acrylic resin” in the present disclosure includes both resins having an acrylic monomer unit having an acryloyl group and resins having a methacrylic monomer unit having a methacryloyl group.

### <Electrode Slurry Additive>

The electrode slurry additive according to the present disclosure is an acrylic resin including a structural unit having a linear alkyl group with 14 or more carbon atoms and a structural unit having a basic functional group, has a weight average molecular weight that is greater than 50,000 and less than 200,000, and has an amine value of from 5 mg KOH/g to 33 mg KOH/g.

The electrode slurry additive according to the present disclosure can, by virtue of having the above configuration, improve the dispersion stability of components in a slurry. We surmise that reasons for this may be as follows.

Because the electrode slurry additive includes the structural unit having a basic functional group and has an amine value of from 5 mg KOH/g to 33 mg KOH/g, the electrode slurry additive efficiently adsorbs on components (such as an active material) in a slurry. Furthermore, because the weight average molecular weight is in the range of greater than 50,000 to less than 200,000, adsorption stability improves. Moreover, because the electrode slurry additive includes the structural unit having a linear alkyl group with 14 or more carbon atoms, the dispersion stability of components in a slurry improves.

For the above reasons, the electrode slurry additive according to the present disclosure can improve the dispersion stability of components in a slurry.

### (Structure)

The electrode slurry additive according to the present disclosure is an acrylic resin including a structural unit having a linear alkyl group with 14 or more carbon atoms and a structural unit having a basic functional group. The structural unit having a linear alkyl group with 14 or more carbon atoms is preferably a structural unit derived from a polymerizable unsaturated monomer having a linear alkyl with 14 or more carbon atoms. Furthermore, the structural unit having a basic functional group is preferably a structural unit derived from a polymerizable unsaturated monomer having a basic functional group.

The electrode slurry additive according to the present disclosure which is an acrylic resin is preferably a copolymer and may be either a random copolymer or a block copolymer and is preferably a random copolymer.

Among acrylic resins, it is preferred that the acrylic resin be a poly(meth)acrylic acid ester from the standpoint of the dispersibility of the electrode slurry.

—Structural Unit Having Linear Alkyl Group with 14 or More Carbon Atoms—

The electrode slurry additive according to the present disclosure includes a structural unit having a linear alkyl group with 14 or more carbon atoms. The number of carbon atoms in the linear alkyl group is preferably 16 or more and more preferably 18 or more from the standpoint of the dispersibility of the conductive aid. The number of carbon atoms in the linear alkyl group is preferably from 16 to 24, and more preferably from 18 to 22. Only one type of structural unit having a linear alkyl group with 14 or more carbon atoms may be used, or two or more types of structural unit having a linear alkyl group with 14 or more carbon atoms may be used in combination.

Specific examples of the linear alkyl group with 14 or more carbon atoms include a tetradecyl group, a pentadecyl group, a hexadecyl group, a heptadecyl group, an octadecyl (stearyl) group, a nonadecyl group, an eicosyl group, and a behenyl group, and the linear alkyl group with 14 or more carbon atoms is more preferably an octadecyl (stearyl) group or a behenyl group.

Examples of the structural unit having a linear alkyl group with 14 or more carbon atoms include a structural unit represented by Formula 1 below.

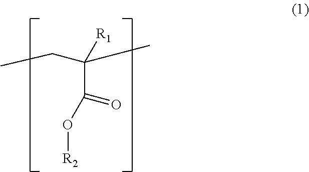

In Formula (1) above, R₁ is a hydrogen atom or a methyl group, and R₂ is a linear alkyl group with 14 or more carbon atoms.

R₁ is preferably a methyl group.

Specific examples of the linear alkyl group with 14 or more carbon atoms denoted by R₂ include those already mentioned, and preferred aspects are also the same.

The content ratio of the structural unit having a linear alkyl group with 14 or more carbon atoms is, from the standpoint of the dispersibility of components in the slurry, preferably from 30% by mass to 65% by mass, more preferably from 35% by mass to 60% by mass, and even more preferably from 40% by mass to 55% by mass relative to all structural units included in the acrylic resin. When the content ratio of the structural unit having a linear alkyl group with 14 or more carbon atoms is 30% by mass or more, the dispersibility of the conductive aid further improves. When the content ratio of the structural unit having a linear alkyl group with 14 or more carbon atoms is 65% by mass or less, the dispersibility of the active material and the solid-state electrolyte further improves.

Examples of the structural unit having a linear alkyl group with 14 or more carbon atoms include a structural unit derived from a polymerizable unsaturated monomer having a linear alkyl group with 14 or more carbon atoms.

Specific examples of the polymerizable unsaturated monomer having a linear alkyl group with 14 or more carbon atoms include tetradecyl (meth)acrylate, pentadecyl (meth)acrylate, hexadecyl (meth)acrylate, heptadecyl (meth)acrylate, stearyl (meth)acrylate, nonadecyl (meth)acrylate, eicosyl (meth)acrylate, heneicosyl (meth)acrylate, behenyl (meth)acrylate, tricosyl (meth)acrylate, and tetracosyl (meth)acrylate. Only one of these may be used, or two or more thereof may be used in combination.

### —Structural Unit Having Basic Functional Group—

The electrode slurry additive according to the present disclosure includes a structural unit having a basic functional group.

“Basic functional group” means a functional group that exhibits a Bronsted base characteristic in an aqueous solution.

Examples of the basic functional group include a primary amino group, a secondary amino group, a tertiary amino group, a quaternary ammonium salt group, an imino group, a hydrazino group, a pyridyl group, a pyrimidyl group, a pyrazyl group, an imidazole group, a triazole group, and an amido group. The structural unit may have just one type of these basic functional groups or may have two or more types of these basic functional groups. Among these, from the standpoint of the dispersibility of the electrode slurry, the basic functional group is preferably at least one type of basic functional group selected from the group consisting of a secondary amino group, a tertiary amino group, an imino group, and an amido group.

Examples of the structural unit having a basic functional group include a structural unit represented by Formula (2) below.

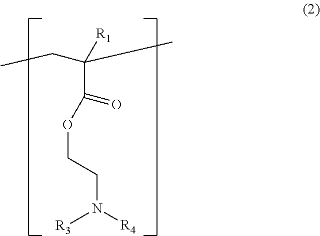

In Formula (2) above, R₁ has the same definition as that of R₁ in Formula (1) above, and each of R₃ and R₄ is independently a hydrogen atom or an alkyl group with one or more carbon atoms.

R₁ is preferably a methyl group.

Each of R₃ and R₄ is preferably an alkyl group with 1 to 6 carbon atoms, more preferably an alkyl group with 1 to 3 carbon atoms, and even more preferably a methyl group.

The content ratio of the structural unit having a basic functional group is, from the standpoint of adsorption to components in the slurry, preferably from 0.5% by mass to 10% by mass, more preferably from 1% by mass to 8% by mass, and even more preferably from 1.5% by mass to 6% by mass relative to all structural units included in the acrylic resin. When the content ratio of the structural unit having a basic functional group is 0.5% by mass or greater, the dispersibility of the conductive aid and the active material further improves. When the content ratio of the structural unit having a basic functional group is 10% by mass or less, an excellent dispersibility of the solid-state electrolyte is obtained.

Examples of the structural unit having a basic functional group include a structural unit derived from a polymerizable unsaturated monomer having a basic functional group. Any polymerizable unsaturated monomer having a basic functional group can be used without particular limitations as long as the monomer has a basic functional group.

Specific examples of the polymerizable unsaturated monomer having a basic functional group include (meth)acrylamide, N-methyl (meth)acrylamide, N-ethyl (meth)acrylamide, N-propyl (meth)acrylamide, N-isopropyl (meth)acrylamide, N-butyl (meth)acrylamide, N-tert-butyl (meth)acrylamide, N,N-dimethyl (meth)acrylamide, N,N-diethyl (meth)acrylamide, N,N-dimethylaminoethyl (meth)acrylate, N,N-diethylaminoethyl (meth)acrylate, N,N-dimethylaminopropyl (meth)acrylamide, and an adduct formed from glycidyl (meth)acrylate and an amine. Only one of these may be used, or two or more thereof may be used in combination.

### —Other Structural Units—

The electrode slurry additive according to the present disclosure may include other (additional) structural units in addition to the structural unit having a linear alkyl group with 14 or more carbon atoms and the structural unit having a basic functional group.

Specific examples of such additional structural units include structural units derived from the following polymerizable unsaturated monomers.

Examples of the polymerizable unsaturated monomers include linear, branched, or cyclic alkyl group-containing (meth)acrylates such as methyl (meth)acrylate, ethyl (meth)acrylate, n-propyl (meth)acrylate, isopropyl (meth)acrylate, n-butyl (meth)acrylate, isobutyl (meth)acrylate, tert-butyl (meth)acrylate, 2-ethylhexyl (meth)acrylate, n-octyl (meth)acrylate, lauryl (meth)acrylate, isostearyl acrylate, cyclohexyl (meth)acrylate, isobornyl (meth)acrylate, and tridecyl (meth)acrylate; polymerizable unsaturated monomers having a monocyclic aromatic hydrocarbon such as styrene, phenyl (meth)acrylate, phenylalkyl (meth)acrylate, and vinyl toluene; polymerizable unsaturated monomers having a polycyclic aromatic hydrocarbon, such as vinyl naphthalene, naphthyl (meth)acrylate, naphthyl alkyl (meth)acrylate, vinyl anthracene, anthracenyl (meth)acrylate, anthracenylalkyl (meth)acrylate, vinyl pyrene, pyrenyl (meth)acrylate, pyrenylalkyl (meth)acrylate, vinyl chrysene, vinyl naphthacene, vinyl pentacene, and derivatives thereof, hydroxyl group-containing polymerizable unsaturated monomers, such as monoesters of (meth)acrylic acid and a dihydric alcohol with 2 to 8 carbon atoms such as 2-hydroxyethyl (meth)acrylate, 2-hydroxypropyl (meth)acrylate, 3-hydroxypropyl (meth)acrylate, and 4-hydroxybutyl (meth)acrylate, ε-caprolactone-modified monoesters of (meth)acrylic acid and a dihydric alcohol with 2 to 8 carbon atoms, N-hydroxymethyl (meth)acrylamide, N,N-bis(2-hydroxymethyl) acrylamide, N-[1,1-bis(hydroxymethyl)-2-hydroxyethyl]propenamide, N-hydroxyethyl (meth)acrylamide, N,N-bis(2-hydroxyethyl) acrylamide, N-hydroxypropyl (meth)acrylamide, N,N-bis(2-hydroxypropyl) acrylamide, N-(1,1-dimethyl-3-hydroxybutyl) acrylamide, allyl alcohol, and (meth)acrylates having a polyoxyalkylene chain with a hydroxyl group at the molecular end; carboxyl group-containing polymerizable unsaturated monomers such as (meth)acrylic acid, maleic acid, crotonic acid, and β-carboxyethyl acrylate; polymerizable unsaturated monomers having a urethane bond such as a reaction product of an isocyanate group-containing polymerizable unsaturated monomer and a hydroxyl group-containing compound or a reaction product of a hydroxyl-containing polymerizable unsaturated monomer and an isocyanate group-containing compound; epoxy group-containing polymerizable unsaturated monomers such as glycidyl (meth)acrylate, β-methyl glycidyl (meth)acrylate, 3,4-epoxycyclohexylmethyl (meth)acrylate, 3,4-epoxycyclohexylethyl (meth)acrylate, 3,4-epoxycyclohexylpropyl (meth)acrylate, and allyl glycidyl ether; (meth)acrylates having a polyoxyethylene chain with an alkoxy group at the molecular end; polymerizable unsaturated monomers having a sulfonic acid group such as 2-acrylamido-2-methylpropanesulfonic acid, 2-sulfoethyl (meth)acrylate, allylsulfonic acid, and 4-styrenesulfonic acid, as well as sodium salts and ammonium salts of these sulfonic acids; polymerizable unsaturated monomers having a phosphoric acid group such as 2-(meth)acryloyloxyethyl acid phosphate and 2-(meth)acryloyloxypropyl acid phosphate; polymerizable unsaturated monomers having an alkoxysilyl group such as vinyl trimethoxy silane, vinyl triethoxy silane, vinyl tris(2-methoxyethoxy) silane, γ-(meth)acryloyloxypropyl trimethoxy silane, and γ-(meth)acryloyloxypropyl triethoxy silane; perfluoroalkyl (meth)acrylates such as perfluorobutylethyl (meth)acrylate and perfluorooctylethyl (meth)acrylate; polymerizable unsaturated monomers having a fluorinated alkyl group such as fluoroolefin; polymerizable unsaturated monomers having a photopolymerizable functional group such as a maleimide group; alkoxy (meth)acrylates such as methoxy (meth)acrylate, ethoxy (meth)acrylate, and butoxy (meth)acrylate; and polymerizable unsaturated monomers having two or more unsaturated groups such as allyl (meth)acrylate, ethylene glycol di(meth)acrylate, triethylene glycol di(meth)acrylate, tetraethylene glycol di(meth)acrylate, 1,3-butylene glycol di(meth)acrylate, trimethylolpropane tri(meth)acrylate, 1,4-butanediol di(meth)acrylate, neopentylglycol di(meth)acrylate, 1,6-hexanediol di(meth)acrylate, pentaerythritol di(meth)acrylate, pentaerythritol tetra(meth)acrylate, glycerol di(meth)acrylate, 1,1,1-trishydroxymethylethane di(meth)acrylate, 1,1,1-trishydroxymethylethane tri(meth)acrylate, 1,1,1-trishydroxymethylpropane tri(meth)acrylate, triallyl isocyanurate, diallyl terephthalate, and divinylbenzene.

Among these polymerizable unsaturated monomers, using particularly a polymerizable unsaturated monomer having an alkyl group having from 4 to less than 8 carbon atoms is preferred from the standpoint of the dispersibility of the conductive aid. —Specific Structure of Electrode Slurry Additive—

The electrode slurry additive according to the present disclosure may be a random polymer or a block polymer but is preferably a random polymer from the standpoint of dispersion stability.

Furthermore, the electrode slurry additive according to the present disclosure is preferably a poly(meth)acrylic acid ester from the standpoint of dispersion stability.

Below, specific examples of the acrylic resin which is the electrode slurry additive according to the present disclosure are described. However, the electrode slurry additive according to the present disclosure is not limited to these. It will be noted that the acrylic resins in Table 1 are all random polymers. Furthermore, the “% by mass” numerical values for each structural unit in Table 1 mean the percentage of the mass of each structural unit relative to all structural units included in the acrylic resin.

| Acrylic Resin Type | | a-1 | a-2 | a-3 | a-4 | a-5 | a-6 | a-7 | a-8 |
|---|---|---|---|---|---|---|---|---|---|
| Polymerizable | Stearyl methacrylate | 40 | 58 | 30 | 40 | — | 10 | 40 | 40 |
| unsaturated | (18 carbon atoms) | | | | | | | | |
| monomers having | Behenyl methacrylate | — | — | — | — | 40 | 21 | — | — |
| linear alkyl | (22 carbon atoms) | | | | | | | | |
| Polymerizable | N,N-dimethylaminoethyl | 2 | 2 | 2 | 6 | 2 | 2 | 2 | 2 |
| unsaturated | methacrylate | | | | | | | | |
| monomer having | | | | | | | | | |
| basic functional | | | | | | | | | |
| group | | | | | | | | | |
| Other monomers | Isobutyl acrylate | 40 | 40 | 41 | 40 | 40 | 40 | 40 | 40 |
| | (branched, 4 carbon atoms) | | | | | | | | |
| | Isobutyl methacrylate | 18 | — | 27 | 14 | 18 | 27 | 18 | 18 |
| | (branched, 4 carbon atoms) | | | | | | | | |
| Physical | Amine value (mg KOH/g) | 7 | 7 | 7 | 22 | 7 | 7 | 7 | 7 |
| properties | Weight average molecular | 110 | 110 | 110 | 110 | 110 | 110 | 80 | 150 |
| | weight (×10³) | | | | | | | | |

### (Weight Average Molecular Weight)

The electrode slurry additive according to the present disclosure has a weight average molecular weight that is greater than 50,000 and less than 200,000. From the standpoint of dispersion stability, the weight average molecular weight of the electrode slurry additive is preferably from 60,000 to 180,000, more preferably from 70,000 to 170,000, even more preferably from 80,000 to 160,000, and also preferably from 100,000 to 160,000.

### —Measurement of Weight Average Molecular Weight—

The weight average molecular weight of the electrode slurry additive according to the present disclosure is a value obtained by converting retention time (retention volume) measured using a gel permeation chromatograph (GPC) to the molecular weight of polystyrene, based on the retention time values (retention volumes) of standard polystyrenes with known molecular weights measured under the same conditions. For example, measurement may be carried out using a HLC-8120 GPC (product name, manufactured by Tosoh Corporation) as the GPC, and four columns, specifically TSKGEL G4000HXL, TSKGEL G3000HXL, TSKGEL G2500HXL, and TSKGEL G2000HXL (product names, all manufactured by Tosoh Corporation) as the columns, under the conditions of mobile phase tetrahydrofuran, a measurement temperature of 40° C., a flow rate of 1 mL/min, and detector RI.

### (Amine Value)

The amine value of the electrode slurry additive according to the present disclosure is from 5 mg KOH/g to 33 mg KOH/g. From the standpoint of the dispersibility and conductivity of the electrode slurry, the amine value of the electrode slurry additive is preferably from 6 mg KOH/g to 30 mg KOH/g, more preferably from 6 mg KOH/g to 25 mg KOH/g, and also preferably from 6 mg KOH/g to 15 mg KOH/g.

### ˜Measurement of Amine Value˜

The amine value of the electrode slurry additive is measured in conformity with JIS K 7237 (1995).

### (Method of Synthesizing Electrode Slurry Additive)

The electrode slurry additive according to the present disclosure can be synthesized by copolymerizing a polymerizable unsaturated monomer having a linear alkyl group with 14 or more carbon atoms, a polymerizable unsaturated monomer having a basic functional group, and optionally another polymerizable unsaturated monomer as needed. Conventionally known methods can be used for the synthesis. For example, the electrode slurry additive can be prepared by solution polymerization of the polymerizable unsaturated monomers in an organic solvent. However, the method is not limited thereto. For example, bulk polymerization, emulsion polymerization, or suspension polymerization may be employed. When performing solution polymerization, the solution polymerization may be continuous polymerization or batch polymerization. The polymerizable unsaturated monomers may be charged all at once, or may be charged in portions, or may be continuously or intermittently added.

### —Polymerizable Unsaturated Monomers—

Details about the polymerizable unsaturated monomer having a linear alkyl group with 14 or more carbon atoms, the polymerizable unsaturated monomer having a basic functional group, and other polymerizable unsaturated monomers used in the synthesis of the electrode slurry additive according to the present disclosure are as have already been described, so description here will be omitted.

### —Radical Polymerization Initiator—

For the radical polymerization initiator used in the polymerization, conventionally known radical polymerization initiators can be used. Examples of radical polymerization initiators include peroxide-based polymerization initiators such as cyclohexanone peroxide, 3,3,5-trimethylcyclohexanone peroxide, methylcyclohexanone peroxide, 1,1-bis(tert-butylperoxy)-3,3,5-trimethylcyclohexane, 1,1-bis(tert-butylperoxy)cyclohexane, n-butyl-4,4-bis(tert-butylperoxy)valerate, cumene hydroperoxide, 2,5-dimethylhexane-2,5-dihydroperoxide, 1,3-bis(tert-butylperoxy-m-isopropyl)benzene, 2,5-dimethyl-2,5-di(tert-butylperoxy)hexane, diisopropylbenzene peroxide, tert-butylcumyl peroxide, decanoyl peroxide, lauroyl peroxide, benzoyl peroxide, 2,4-dichlorobenzoyl peroxide, di-tert-amyl peroxide, bis(tert-butylcyclohexyl)peroxydicarbonate, tert-butylperoxybenzoate, 2,5-dimethyl-2,5-di(benzoylperoxy)hexane, and tert-butylperoxy-2-ethylhexanoate; and azo-based polymerization initiators such as 2,2′-azobis(isobutyronitrile), 1,1-azobis(cyclohexane-1-carbonitrile), azocumene, 2,2′-azobis(2-methylbutyronitrile), 2,2′-azobisdimethylvaleronitrile, 4,4′-azobis(4-cyanovaleric acid), 2-(t-butylazo)-2-cyanopropane, 2,2′-azobis(2,4,4-trimethylpentane), 2,2′-azobis(2-methylpropane), and dimethyl 2,2′-azobis(2-methylpropionate). Only one of radical polymerization initiator may be used, or two or more thereof may be used in combination.

### —Solvent—

The solvent used in the above-described polymerization and/or dilution is not particularly limited, and examples thereof include water, organic solvents, or mixtures thereof.

For organic solvents, conventionally known solvents can be used. Examples of organic solvents include hydrocarbon-based solvents such as n-butane, n-hexane, n-heptane, n-octane, cyclopentane, cyclohexane, and cyclobutane; aromatic-based solvents such as toluene, xylene, mesitylene, and tetralin; ether-based solvents such as n-butyl ether, dioxane, ethylene glycol monomethyl ether, ethylene glycol monoethyl ether, ethylene glycol monopropyl ether, ethylene glycol monobutyl ether, and diethylene glycol; ester-based solvents such as ethyl acetate, n-butyl acetate, isobutyl acetate, butyl butyrate, ethylene glycol monomethyl ether acetate, and butyl carbitol acetate; ketone-based solvents such as methyl ethyl ketone, methyl isobutyl ketone, and diisobutyl ketone; alcohol-based solvents such as ethanol, isopropanol, n-butanol, sec-butanol, and isobutanol; and amide-based solvents such as EQUAMIDE (product name, manufactured by Idemitsu Kosan Co., Ltd.), N,N-dimethylformamide, N,N-dimethylacetamide, N-methylformamide, N-methylacetamide, N-methylpropioamide and N-methyl-2-pyrrolidone.

Only one solvent may be used, or two or more thereof may be used in combination.

The solvent used in the polymerization and/or dilution will be present in a mixed state with the electrode slurry additive in a case where removal by solvent removal processing is not performed. Therefore, it is preferred that the polymerization and/or dilution be performed using a solvent that is to be used in the later-described preparation of the electrode slurry.

When performing solution polymerization in an organic solvent, methods that can be used include a method where the radical polymerization initiator, the polymerizable unsaturated monomers, and the organic solvent are mixed, and heated while being stirred, and a method where the organic solvent is charged into a reaction tank, an inert gas such as nitrogen or argon is blown in if necessary while the solvent is stirred at a temperature of 60° C. to 200° C., and the polymerizable unsaturated monomers and the radical polymerization initiator are added dropwise together or added dropwise separately over a predetermined amount of time, so that a rise in the temperature of the system caused by reaction heat is curbed.

The polymerization can usually be performed for a period of from about 1 hour to 10 hours. An additional catalysis step of heating the reaction tank while adding dropwise the radical polymerization initiator may be provided as needed after each stage of the polymerization.

### <Battery>

The battery according to the present disclosure includes the above-described electrode slurry additive according to the present disclosure.

The battery according to the present disclosure preferably includes a positive electrode, a negative electrode, and an electrolyte disposed between the positive electrode and the negative electrode and is preferably a solid-state battery that includes a solid-state electrolyte layer as the electrolyte. The positive electrode preferably includes a positive electrode layer and a positive electrode current collector, and the negative electrode preferably includes a negative electrode layer and a negative electrode current collector. Examples of the layer-stack structure of the solid-state battery according to the present disclosure include positive electrode current collector/positive electrode layer/electrolyte layer/negative electrode layer/negative electrode current collector. The solid-state battery according to the present disclosure may have a configuration where at least one selected from the group consisting of the positive electrode layer, the electrolyte layer, and the negative electrode layer includes the electrode slurry additive according to the present disclosure.

The scope of the solid-state battery includes an all-solid-state battery in which a solid-state electrolyte is used as the electrolyte, and the solid-state electrolyte may include an electrolytic solution at a content of less than 10% by mass relative to the total amount of the electrolyte. It will be noted that the solid-state electrolyte may be a composite solid-state electrolyte including an inorganic solid-state electrolyte and a polymer electrolyte.

### (Positive Electrode)

The positive electrode preferably includes a positive electrode layer and a positive electrode current collector. The positive electrode layer contains a positive electrode active material and a solid-state electrolyte, and may further contain, if necessary, a component selected from the electrode slurry additive according to the present disclosure, a conductive aid, a binder, or another components.

### —Positive Electrode Layer—

The positive electrode layer preferably includes a lithium complex oxide as the positive electrode active material. The lithium complex oxide may contain at least one selected from the group consisting of F, Cl, N, S, Br, and I.

As the solid-state electrolyte, the positive electrode layer preferably includes at least one solid-state electrolyte selected from the group consisting of a sulfide solid-state electrolyte, an oxide solid-state electrolyte, and a halide solid-state electrolyte, and more preferably includes a sulfide solid-state electrolyte.

The sulfide solid-state electrolyte preferably contains sulfur (S) as the main anion element. For example, the sulfide solid-state electrolyte preferably contains a Li element, an element A, and an S element. The element A is at least one selected from the group consisting of P, As, Sb, Si, Ge, Sn, B, Al, Ga, and In. The sulfide solid-state electrolyte may further contain at least one of O or a halogen element.

Examples of conductive aids include carbon materials, metal materials, and conductive polymer materials.

Examples of binders include vinyl halide resins, rubbers, and polyolefin resins.

Examples of other components include oxide solid-state electrolytes, halide solid-state electrolytes, thickeners, surfactants, dispersants, wetting agents, antifoaming agents, and solvents.

Examples of solvents include the organic solvents that are described above as solvents usable in the synthesis of the electrode slurry additive of the present disclosure. In the present disclosure, ester-based, ether-based, ketone-based, and hydrocarbon-based solvents are preferred as the solvent, and among these, solvents selected from the group consisting of butyl butyrate, dibutyl ether, anisole, mesitylene, diisobutyl ketone, methyl isobutyl ketone, cyclopentyl methyl ether, toluene, and heptane are more preferred, and solvents selected from the group consisting of anisole, mesitylene, diisobutyl ketone, and methyl isobutyl ketone are even more preferred.

When preparing a slurry for an electrode or an electrolyte layer, it is difficult to simultaneously and stably disperse the three materials that are a conductive aid, an electrolyte (particularly a solid-state electrolyte), and an active material. In the present disclosure, since the above-described electrode slurry additive is contained, the mixture system including the three materials that are the conductive aid, the electrolyte (particularly a solid-state electrolyte), and the active material can be stably dispersed while maintaining low reactivity with the electrolyte (particularly a solid-state electrolyte).

### —Positive Electrode Current Collector—

Examples of positive electrode current collectors include stainless steel, aluminum, nickel, iron, titanium, and carbon, with aluminum alloy foil or aluminum foil being preferred. The shape of the positive electrode current collector may, for example, be foil-shaped or mesh-shaped.

### (Negative Electrode)

The negative electrode preferably includes a negative electrode layer and a negative electrode current collector. The negative electrode layer contains a negative electrode active material and a solid-state electrolyte and may contain, if necessary, a component selected from the electrode slurry additive according to the present disclosure, a conductive aid, a binder, or another component.

### —Negative Electrode Layer—

Examples of negative electrode active materials include Li-based active materials such as metal lithium, carbon-based active materials such as graphite, oxide-based active materials such as lithium titanate, and Si-based active materials such as elemental Si.

For the solid-state electrolyte, the conductive aid, the binder, and the other components, those described above may be applied.

### —Negative Electrode Current Collector—

The negative electrode current collector collects current for the negative electrode layer. Examples of negative electrode current collectors include stainless steel, aluminum, copper, nickel, iron, titanium, and carbon, with copper being preferred. The shape of the negative electrode current collector may, for example, be foil-shaped or mesh-shaped.

### (Electrolyte Layer)

The electrolyte layer may be a layer including a solid-state electrolyte. In a case where the electrolyte layer is a layer including a solid-state electrolyte (a solid-state electrolyte layer), the solid-state electrolyte layer preferably includes one selected from the group consisting of a sulfide solid-state electrolyte, an oxide solid-state electrolyte, and a halide solid-state electrolyte. The solid-state electrolyte layer may include the electrode slurry additive according to the present disclosure and a binder or may not include a binder. As binders that can be included in the solid-state electrolyte layer, the binders described above may be applied.

The FIGURE is a schematic cross-sectional view illustrating one embodiment of the battery of the present disclosure. A battery 10 shown in the FIGURE includes a positive electrode layer 1 that contains a positive electrode active material, a negative electrode layer 2 that contains a negative electrode active material, an electrolyte layer 3 disposed between the positive electrode layer 1 and the negative electrode layer 2, a positive electrode current collector 4 that collects electric current for the positive electrode layer 1, a negative electrode current collector 5 that collects electric current for the negative electrode layer 2, and an outer casing 6 that accommodates these members. The battery 10 may have a configuration where at least one selected from the group consisting of the positive electrode layer 1, the electrolyte layer 3, and the negative electrode layer 2 includes the electrode slurry additive according to the present disclosure.

### <Method of Producing Solid-State Battery>

The method of producing the solid-state battery according to the present disclosure includes a step (a preparation step) of preparing the positive electrode, the negative electrode, and the electrolyte layer or a separator and a step (a stacking step) of stacking the positive electrode, the electrolyte layer or the separator, and the negative electrode in this order.

### (Preparation Step)

The preparation step is a step of preparing the positive electrode, the negative electrode, and the electrolyte layer or the separator.

The method of preparing each of the positive electrode, the negative electrode, and the electrolyte layer is not particularly limited but is preferably a method where a solvent and components that can be contained in the positive electrode layer, negative electrode layer, or electrolyte layer are kneaded to obtain a slurry, then the obtained slurry is applied to a substrate and dried to obtain a dried film, and the dried film is pressed.

As the electrode slurry used in the preparation of each of the positive electrode and the negative electrode, for example, a slurry including the electrode slurry additive according to the present disclosure, an active material, a conductive aid, a solid-state electrolyte, and a solvent (and preferably a binder) is preferred. As the solvent, cases where the electrode slurry contains at least one selected from the group consisting of ester-based, ether-based, ketone-based, and hydrocarbon-based solvents are effective in terms of stabilizing dispersion, cases where the electrode slurry contains a solvent selected from the group consisting of butyl butyrate, dibutyl ether, anisole, mesitylene, diisobutyl ketone, methyl isobutyl ketone, cyclopentyl methyl ether, toluene, and heptane are more effective in terms of stabilizing dispersion, and cases where the electrode slurry contains a solvent selected from the group consisting of anisole, mesitylene, diisobutyl ketone, and methyl isobutyl ketone are even more effective in terms of stabilizing dispersion. That is, when using the above solvents to prepare a slurry including an active material, a conductive aid, and a solid-state electrolyte, the active material, the conductive aid, and the solid-state electrolyte can be simultaneously and stably dispersed, with the result that battery performance can be improved.

Examples of methods of pressing the dried film include roll pressing and cold isostatic pressing (CIP).

### (Stacking Step)

The staking step is a step of stacking the positive electrode, the electrolyte layer or the separator, and the negative electrode in this order.

The stacking step preferably includes stacking the positive electrode, the electrolyte layer or the separator, and the negative electrode, which have been prepared in the preparation step, in this order, and optionally performing pressing, if necessary, to obtain a stacked body (electrode body).

The solid-state battery according to the present disclosure is preferably produced via the above steps.

### EXAMPLES

Examples are described below in regard to embodiments pertaining to the electrode slurry additive according to the present disclosure and related products. However, the present invention is not limited to these Examples. It will be noted that in the following description “parts” and “%” are all based on mass unless otherwise specified.

A procedure for synthesizing the electrode slurry additive and a procedure for producing the all-solid-state battery are described below. It will be noted that the structures of polymers 1 to 8 (the electrode slurry additive according to the present disclosure) are those of polymers 1 to 8 shown in Table 1 presented above.

### Example 1

### (Synthesis of Electrode Slurry Additive)

40 parts of diisobutyl ketone were charged into a reaction container equipped with a stirring and heating device and a cooling tube and maintained at 80° C. after nitrogen substitution. The monomer mixture described below was added dropwise thereto over a period of 6 hours.

### <Monomer Mixture>

Stearyl methacrylate (a polymerizable unsaturated monomer for forming a structural unit having a linear alkyl group with 14 or more carbon atoms): 40 parts
N,N-dimethylaminoethyl methacrylate (a polymerizable unsaturated monomer for forming a structural unit having a basic functional group): 2 parts
Isobutyl acrylate (another polymerizable unsaturated monomer): 40 parts
Isobutyl methacrylate (another polymerizable unsaturated monomer): 18 parts
2,2′-azobis(isobutyronitrile) (a radical polymerization initiator): 0.3 parts

One hour after the end of the dropwise addition, a solution of 0.5 parts of 2,2′-azobis(isobutyronitrile) (not included in the calculation of the amount indicated in Table 1) dissolved in 10 parts of propylene glycol monomethyl ether was added dropwise thereto over a period of 1 hour. This was maintained at 80° C. for another hour. Thereafter, diisobutyl ketone was added so that the solid content was 5% to obtain a solution of acrylic resin (a-1; electrode slurry additive).

The acrylic resin (a-1) was a random copolymer having a weight average molecular weight of 110,000.

(Production of all-Solid-State Battery)

### —Preparation Step—

### Preparation of Positive Electrode

A positive electrode slurry was obtained by adding the above solution of acrylic resin (a-1; electrode slurry additive), 2 g of a positive electrode active material (LiNi_{0.33}Co_{0.33}Mn_{0.33}O₂), 0.03 g of a carbon material as a conductive aid (VGCF-H manufactured by RESONAC Corporation; VGCF is a registered trademark), 0.3 g of a sulfide solid-state electrolyte (Li₂S—P₂S₅), and 0.3 g of a diisobutyl ketone solution including 5% by mass of poly(vinylidene fluoride-co-hexafluoropropylene) as a binder to 1 g of butyl butyrate as a solvent and dispersing the mixture for 10 minutes with ultrasonic waves having an amplitude of 40 μm and a frequency of 20 kHz. The slurry was blade-coated with a gap of 100 μm on an aluminum foil as a substrate (positive electrode current collector). This was dried at 100° C. for 30 minutes to prepare a positive electrode having a positive electrode layer on a positive electrode current collector.

### Preparation of Negative Electrode

A negative electrode slurry was obtained by adding the above solution of acrylic resin (a-1; electrode slurry additive), 1 g of a negative electrode active material (elemental Si), 0.13 g of a carbon material as a conductive aid (VGCF-H manufactured by RESONAC Corporation; VGCF is a registered trademark), 1.2 g of a sulfide solid-state electrolyte (Li₂S—P₂S₅), and 0.8 g of a diisobutyl ketone solution including 5% by mass of poly(vinylidene fluoride-co-hexafluoropropylene) as a binder to 2.7 g of diisobutyl ketone as a solvent and dispersing the mixture for 10 minutes with ultrasonic waves having an amplitude of 40 μm and a frequency of 20 kHz. The slurry was blade-coated with a gap of 100 μm on a nickel foil as a substrate (negative electrode current collector). This was dried at 100° C. for 30 minutes to prepare a negative electrode having a negative electrode layer on a negative electrode current collector.

### Preparation of Electrolyte Layer

An electrolyte slurry was obtained by adding 0.4 g of Li₂S—P₂S₅ (a sulfide solid-state electrolyte) and 0.05 g of a heptane solution including 5% by mass of acrylonitrile-butadiene rubber (ABR) as a binder to 0.8 g of heptane as a solvent and dispersing the mixture for 10 minutes with ultrasonic waves having an amplitude of 40 μm and a frequency of 20 kHz. The obtained slurry was blade-coated with a gap of 50 μm on a stainless foil as a substrate. The coated film was dried at 100° C. for 30 minutes to prepare an electrolyte layer on a substrate.

### (Stacking Step)

The electrolyte layer was superimposed on the negative electrode current collector of the negative electrode, the stainless foil as the substrate attached to the electrolyte layer was removed, and the stacked body of the negative electrode and the electrolyte layer was roll pressed under a linear pressure of 3 t/cm at room temperature. Another layer of the electrolyte layer was superimposed on the positive electrode current collector of the positive electrode, the stainless foil as the substrate attached to the electrolyte layer was removed, and the stacked body of the positive electrode and the electrolyte layer was roll pressed under a linear pressure of 4 t/cm at 170° C. The stacked body of the negative electrode and the electrolyte layer and the stacked body of the positive electrode and the electrolyte layer, which had been roll pressed, were each punched to a size of 1 cm². The stacked body of the negative electrode and the electrolyte layer and the stacked body of the positive electrode and the electrolyte layer, which had been punched out, were superimposed with the electrolyte layers contacting each other, and joined, thereby producing an all-solid-state battery.

### Examples 2 to 8 and Comparative Examples 1 to 8

All-solid-state batteries were produced by preparing an electrode slurry in the same way as in Example 1 except that the electrode slurry additive and the like were changed as shown in Table 2 and Table 3 below.

### (Synthesis of Electrode Slurry Additive)

—Synthesis of Polymers (a-2) to (a-6) and Polymer (a-8)—

Solutions of acrylic resin (electrode slurry additives) were prepared in the same way as in the synthesis of the acrylic resin (a-1) except that the mixing ratios of the polymerizable unsaturated monomers and the like were changed as shown in Table 2.

—Synthesis of Polymer (a-7)—

A solution of acrylic resin (a-7; electrode slurry additive) was prepared in the same way as in the synthesis of the acrylic resin (a-1) except that the quantity of the initiator was changed from 0.3 parts to 0.6 parts.

—Synthesis of Comparative Polymer (a-11)—

A solution of acrylic resin (a-11; electrode slurry additive) was prepared in the same way as in the synthesis of the acrylic resin (a-1) except that the type and amount of the initiator and the synthesis conditions for the polymer (electrode slurry additive) were changed as shown in Table 3.

—Synthesis of Comparative Polymers (a-12) to (a-18)—

Solutions of acrylic resin (electrode slurry additive) were prepared in the same way as in the synthesis of the acrylic resin (a-1) except that the mixing ratio of the polymerizable unsaturated monomers and the like were changed as shown in Table 3.

### <Measurement and Evaluation>

### —Weight Average Molecular Weights and Amine Values of Electrode Slurry Additives—

The weight average molecular weight and the amine value of the polymer obtained in each of the Examples were measured as described under the headings “Measurement of Weight Average Molecular Weight” and “Measurement of Amine Value” described above.

### —Evaluation of Slurry Particle Size—

The particle sizes of the obtained negative electrode slurries were measured in conformity with JIS K5600-2-5 (1999). The smaller the particle size value, the higher the dispersion stability of the components in the slurry.

### —Evaluation of Resistance Value—

The obtained all-solid-state batteries were CCCV-charged at a rate of 1/3 C to 4.35 V and then discharged at 1/3 C to 3.35 V. Thereafter, discharging was further performed at 7 C and resistance was calculated from the change in voltage in 10 seconds.

| | | | Exam- | Exam- | Exam- | Exam- | Exam- | Exam- | Exam- | Exam- |
|---|---|---|---|---|---|---|---|---|---|---|
| | | | ple 1 | ple 2 | ple 3 | ple 4 | ple 5 | ple 6 | ple 7 | ple 8 |
| | | | a-1 | a-2 | a-3 | a-4 | a-5 | a-6 | a-7 | a-8 |
| Electrode | Polymerizable | Lauryl methacrylate | — | — | — | — | — | — | — | — |
| slurry | unsaturated | (12 carbon atoms) | | | | | | | | |
| additive | monomer having | Stearyl methacrylate | 40 | 58 | 30 | 40 | — | 10 | 40 | 40 |
| | linear alkyl | (18 carbon atoms) | | | | | | | | |
| | with 14 or more | Behenyl methacrylate | — | — | — | — | 40 | 21 | — | — |
| | carbon atoms | (22 carbon atoms) | | | | | | | | |
| | Polymerizable | N,N-dimethylaminoethyl | 2 | 2 | 2 | 6 | 2 | 2 | 2 | 2 |
| | unsaturated | methacrylate | | | | | | | | |
| | monomer having | | | | | | | | | |
| | basic functional | | | | | | | | | |
| | group | | | | | | | | | |
| | Other monomers | Isobutyl acrylate | 40 | 40 | 41 | 40 | 40 | 40 | 40 | 40 |
| | | (branched C4) | | | | | | | | |
| | | Isobutyl methacrylate | 18 | — | 27 | 14 | 18 | 27 | 18 | 18 |
| | | (branched C4) | | | | | | | | |
| | | Isostearyl acrylate | — | — | — | — | — | — | — | — |
| | | (branched C18) | | | | | | | | |
| | | Isobornyl acrylate | — | — | — | — | — | — | — | — |
| | | (alicyclic C18) | | | | | | | | |
| | Initiator | 2,2′-azobis | 0.3 | 0.3 | 0.3 | 0.3 | 0.3 | 0.3 | 0.6 | 0.3 |
| | | (isobutyronitrile) | | | | | | | | |
| | | 2,2′-azobis | — | — | — | — | — | — | — | — |
| | | (2-methylbutyronitrile) | | | | | | | | |

| | | | | | | | | | |
|---|---|---|---|---|---|---|---|---|---|
| Electrode slurry | Synthesis temperature | 80 | 80 | 80 | 80 | 80 | 80 | 80 | 73 |
| additive synthesis | (° C.) | | | | | | | | |
| conditions | Dropwise addition | 6 | 6 | 6 | 6 | 6 | 6 | 6 | 7 |
| | time (h) | | | | | | | | |
| Electrode slurry | Amine value | 7 | 7 | 7 | 22 | 7 | 7 | 7 | 7 |
| additive properties | (mg KOH/g) | | | | | | | | |
| | Weight average | 110 | 110 | 110 | 110 | 110 | 110 | 80 | 150 |
| | molecular weight | | | | | | | | |
| | (×10³) | | | | | | | | |
| Electrode slurry | Slurry particle | 55 | 60 | 60 | 55 | 55 | 50 | 60 | 55 |
| evaluation | size (μm) | | | | | | | | |
| | Resistance value | 35 | 40 | 42 | 38 | 45 | 34 | 33 | 34 |
| | (Ω · cm³) | | | | | | | | |

| | | | Comp. | Comp. | Com. | Comp. | Comp. | Comp. | Comp. | Comp. |
|---|---|---|---|---|---|---|---|---|---|---|
| | | | Exam- | Exam- | Exam- | Exam- | Exam- | Exam- | Exam- | Exam- |
| | | | ple 1 | ple 2 | ple 3 | ple 4 | ple 5 | ple 6 | ple 7 | ple 8 |
| | | | a-11 | a-12 | a-13 | a-14 | a-15 | a-16 | a-17 | a-18 |
| Electrode | Polymerizable | Lauryl methacrylate | — | — | — | 40 | — | — | — | — |
| slurry | unsaturated | (12 carbon atoms) | | | | | | | | |
| additive | monomer having | Stearyl methacrylate | 40 | 40 | — | — | — | — | 40 | — |
| | linear alkyl | (18 carbon atoms) | | | | | | | | |
| | with 14 or more | Behenyl methacrylate | — | — | — | — | — | — | — | 40 |
| | carbon atoms | (22 carbon atoms) | | | | | | | | |
| | Polymerizable | N,N-dimethylaminoethyl | 2 | 2 | 2 | 2 | 2 | 2 | — | 10 |
| | unsaturated | methacrylate | | | | | | | | |
| | monomer having | | | | | | | | | |
| | basic functional | | | | | | | | | |
| | group | | | | | | | | | |
| | Other monomers | Isobutyl acrylate | 40 | 40 | 59 | 40 | 40 | 40 | 36 | 40 |
| | | (branched C4) | | | | | | | | |
| | | Isobutyl methacrylate | 18 | 18 | 39 | 18 | 18 | 18 | 24 | 10 |
| | | (branched C4) | | | | | | | | |
| | | Isostearyl acrylate | — | — | — | — | 40 | — | — | — |
| | | (branched C18) | | | | | | | | |
| | | Isobomyl acrylate | — | — | — | — | — | 40 | — | — |
| | | (alicyclic C18) | | | | | | | | |
| | Initiator | 2,2′-azobis | — | 0.3 | 0.3 | 0.3 | 0.3 | 0.3 | 0.3 | 0.3 |
| | | (isobutyronitrile) | | | | | | | | |
| | | 2,2′-azobis | 0.5 | — | — | — | — | — | — | — |
| | | (2-methylbutyronitrile) | | | | | | | | |

| | | | | | | | | | |
|---|---|---|---|---|---|---|---|---|---|
| Electrode slurry | Synthesis temperature | 95 | 70 | 80 | 80 | 80 | 80 | 80 | 80 |
| additive synthesis | (° C.) | | | | | | | | |
| conditions | Dropwise addition | 3 | 7 | 6 | 6 | 6 | 6 | 6 | 6 |
| | time (h) | | | | | | | | |
| Electrode slurry | Amine value | 7 | 7 | 7 | 7 | 7 | 7 | 0 | 34 |
| | (mg KOH/g) | | | | | | | | |
| additive properties | Weight average | 50 | 200 | 110 | 110 | 110 | 110 | 110 | 110 |
| | molecular weight | | | | | | | | |
| | (×10³) | | | | | | | | |
| Electrode slurry | Slurry particle | >100 | >100 | >100 | 80 | 90 | >100 | >100 | >100 |
| | size (μm) | | | | | | | | |
| evaluation | Resistance value | — | — | — | 47 | 35 | — | — | — |
| | (Ω · cm³) | | | | | | | | |

In Table 2 and Table 3, the dash marks in the cells in a row for a particular component of the electrode slurry mean that that component was not used. Furthermore, the dash marks in the cells in the row for “Resistance value” mean that a battery was unobtainable. “>100” in the cells in the row for “Slurry particle size” means that the slurry particle size exceeded 100 μm.

As is apparent from the results shown in Table 2 and Table 3, it can be seen that in the Examples the electrode slurry additive improves the dispersion stability of the components in the electrode slurry. By contrast, in Comparative Examples 1 to 3 and Comparative Examples 6 to 8, the dispersibility of the components included in the electrode slurry was insufficient and the occurrence of aggregates was seen. For this reason, the electrode slurry could not be applied to the substrate, and an all-solid-state battery could not be produced. Furthermore, in Comparative Examples 4 and 5, although some degree of dispersion could be performed, the slurry particle size was large so dispersion stability was poor and the resistance value also could not be maintained low.

What is claimed is:

1. An electrode slurry additive, which:
is an acrylic resin including a structural unit having a linear alkyl group with 14 or more carbon atoms and a structural unit having a basic functional group,
has a weight average molecular weight that is greater than 50,000 and less than 200,000, and
has an amine value of from 5 mg KOH/g to 33 mg KOH/g.

2. The electrode slurry additive of claim 1, wherein a content ratio of the structural unit having a linear alkyl group with 14 or more carbon atoms is from 30% by mass to 65% by mass relative to all structural units included in the acrylic resin.

3. The electrode slurry additive of claim 1, wherein a content ratio of the structural unit having a basic functional group is from 0.5% by mass to 10% by mass relative to all structural units included in the acrylic resin.

4. The electrode slurry additive of claim 1, wherein the electrode slurry additive is a random polymer.

5. A solid-state battery, comprising the electrode slurry additive of claim 1.
